(19) United States
(12) Patent Application Publication
(10) Pub. No.: US 2018/0266477 A1
(43) Pub. Date: Sep. 20, 2018

(54) Connecting Structural Member

(71) Applicant: Penn Engineering & Manufacturing Corp., Danboro, PA (US)

(72) Inventors: Peng Ni, Nantong City (CN); Dapeng Duan, Kunshan City (CN); Ming Zhang, Kunshan City (CN)

(21) Appl. No.: 15/685,658

(22) Filed: Aug. 24, 2017

(30) Foreign Application Priority Data
Mar. 17, 2017 (CN) 201710154560.6

(51) Int. Cl. F16B 37/12; F16B 4/00

(52) U.S. Cl. CPC F16B 37/122; F16B 4/004

(57) ABSTRACT

An insert for connecting to a receiving structure having at least two parallel members includes having a first end and a second end opposite to the first end; a first spline disposed at the first end of the cylinder, wherein the first spline is arranged circumferentially on an outer surface of the cylinder; and an interlocking clinch disposed at the second end of the cylinder and circumferentially around the cylinder; wherein the first spline and the interlocking clinch are respectively fastened to two parallel members of the structure, and at least one of the first and second ends of the cylinder is fastened to a fitting member through a connecting member. The first spline can be fitted to one member of the structure with interference, and the interlocking clinch is self-fastened with another member of the structure due to material flow.

### FIELD OF THE INVENTION

The present disclosure generally relates to metal-working fastening technology. More particularly, it relates to a reinforcing connecting structural member for connecting objects to parallel plates.

### BACKGROUND OF THE INVENTION

When attaching objects to plates which do not lend themselves to direct thread tapping, there are two conventional fastening methods which connect threaded fasteners such as nuts to plates so that other fitting members can be fastened to the plate. One is welding, and the other is riveting. Welding has high energy consumption and may easily generate thread deformation within the nuts during the welding process. This requires re-tapping the nut and increases costs. Moreover, for aluminum and other materials, the welding process is poor in quality and may produce welding defects easily which adversely influences the effect of fastened connection. On the other hand, with riveting the connection strength and reliability attaching nuts is low. Furthermore, riveting cannot be used where there is limited access to the backside of the plate.

This is most apparent in the case of attaching an internally threaded member to thin-walled parallel surfaces such as one would encounter with “square” tubing or other similar structures For these structures, it is difficult to provide efficient connection using either of the above-mentioned welding and riveting methods. Therefore, there is a need to provide a reinforced connecting structural member for connecting structures with spaced parallel surfaces, which can not only provide effective connection but also increases their strength.

Prior art of which the applicant is aware includes the following U.S. Pat. No. 5,261,759 issued to Decoux; U.S. Pat. No. 5,445,483 issued to Fultz; U.S. Pat. No. 4,842,462 issued to Tildesley; U.S. Pat. No. 3,967,669 issued to Egner; U.S. Pat. No. 3,242,962 issued to Dupree; and U.S. Pat. No. 7,594,788 issued to Maloney.

### SUMMARY OF THE INVENTION

The present disclosure provides a reinforced connecting structural member for connecting objects to structures having spaced parallel plates with planar surfaces.

In one embodiment, a reinforced connecting member or insert for connecting to a receiving structure having at least two parallel plates or surfaces, comprising: a cylinder having a first end and a second end opposite to the first end; a first spline disposed at the first end of the cylinder, wherein the first spline is arranged circumferentially on an outer surface of the cylinder; and interlocking clinch features disposed at the second end of the cylinder and circumferentially around the cylinder; wherein the first spline and the interlocking clinch feature are respectively fastened to two parallel surfaces of the receiving structure, and at least one of the first and second ends of the cylinder is fastened to an object through a connecting member.

Optionally, each of the parallel surfaces of the receiving structure has a mounting hole aligned with a central axis; wherein the first spline is fitted to a first mounting hole with interference; and the interlocking clinch features are fitted to a second mounting hole by pressing.

Optionally, the reinforced connecting member further comprises: a step disposed between the cylinder and the interlocking clinch feature, the step comprising a flange surface perpendicular to an axial direction of the cylinder and a displacer parallel with the outer surface of the cylinder; and wherein an outer diameter of the cylinder is larger than an outer diameter of the displacer.

Optionally, the flange is fitted to a lateral planar surface of the second mounting hole; and an inner diameter of the second mounting hole is larger than an outer diameter of the interlocking clinch features, and smaller than an outer diameter of the displacer.

Optionally, the outer surface of the displacer has a second spline.

Optionally, the cylinder is in contact with and fastened onto an inner surface of the first mounting hole at the first end of the cylinder only through the first spline.

Optionally, the cylinder has a axial hole, the axial hole being one of a threaded blind hole, a threaded through hole, an unthreaded blind hole, an unthreaded through hole, a half threaded hole, an unthreaded step hole or a double-sided and double-ended blind hole.

Optionally, at least one of the first and second ends of the cylinder has a connecting rod extending axially from the cylinder, the connecting rod being an unthreaded rod or a threaded rod.

Optionally, the cylinder, the first spline and the interlocking clinch features which comprise a displacer and an undercut adapted to receive the cold flow of material are formed as a single piece.

Optionally, the cylinder is made of one of an aluminum material, a carbon steel material, or a stainless steel material.

In the present disclosure, the first spline is fitted within a first surface of the receiving structure with broaching inference, and the interlocking clinch features are fastened with the other parallel surface of the structure due to material flow. The insert so described provides a fastened connection with another object by a fitting member such as a bolt even in the case of a thin-walled receiving structure. There are no special requirements for tolerance of the width and thickness of the receiving structure which can be accommodated by changing the dimensions of the cylindrical insert.

It is easy to install the insert of the present disclosure and control the installation quality. No welding or re-tapping is needed, thus the cost and the energy consumption are reduced.

The insert of the present disclosure can connect two faces of the receiving structure together to increase the reliability of the connection. Moreover, the cylinder itself can be used as a stiffener to increase the rigidity of the receiving structure, providing a large support surface to control the deformation of the receiving structure during installation, and providing a strong axial anti-tensile strength.

The flange surface provides positional limitation during installation, no matter how thick the receiving plate. When in use, the entire system is able to withstand a high axial pull-out force due to the flange surface of the cylinder (the direction of the pull-out force is from the first spline to the second spline);

The insert of the present disclosure allows a simple external installation that not only improves the connection strength with the receiving structure, but also reduces the amount of cutting in the manufacturing process. Thus, the manufacturing efficiency is significantly improved, the materials are saved and the energy consumption is reduced.

### BRIEF DESCRIPTION OF THE DRAWINGS

FIG. 1 is a perspective view of a reinforcing connecting structural member according to an embodiment of the present invention;

FIG. 2 is a cross-sectional view of the connecting structural member of FIG. 1;

FIG. 3 is a cross-sectional view a connecting structural member according to an embodiment of the present invention after it is mounted with a receiving structure;

FIG. 4 shows an application of a connecting structural member according to an embodiment of the present invention;

FIG. 5 is a cross-sectional view of a connecting structural member according to another embodiment of the present invention;

FIG. 6 is a cross-sectional view of a connecting structural member according to another embodiment of the present invention after it is mounted with a receiving structure;

FIG. 8 shows a perspective view of a connecting structural member according to another embodiment of the present invention; and,

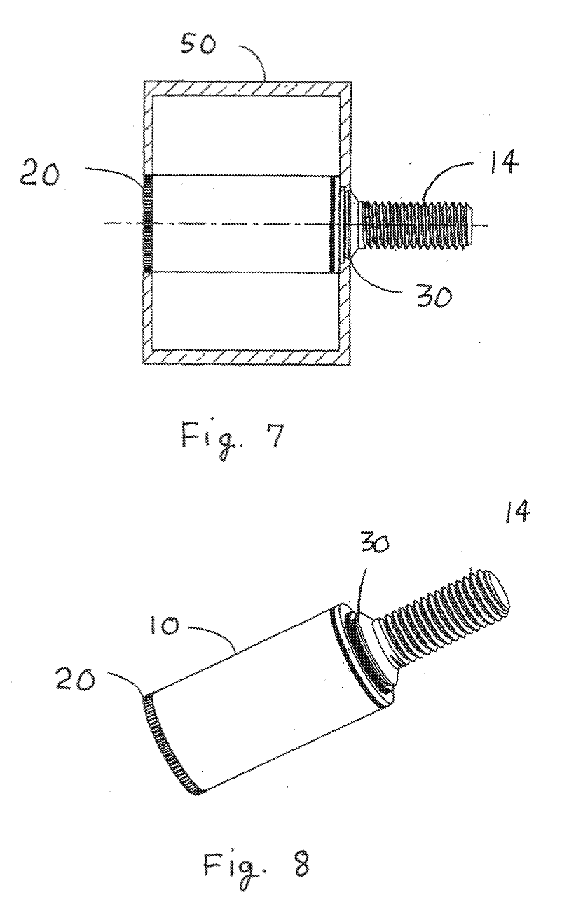

FIG. 7 shows the connecting structural member of FIG. 8 after it is mounted with a receiving structure.

### DETAILED DESCRIPTION OF PREFERRED EMBODIMENTS

In order to make the above-mentioned objects, features and advantages of the present disclosure more obvious, a detailed description of the specific embodiments of the present disclosure will be made with reference to the accompanying drawings. It is to be understood that the drawings of the present disclosure are in a simplified form and are used in a non-precise ratio only for a purpose of facilitating and clarifying the purpose of the embodiments of the present disclosure.

The numbering of parts in the above figures is as follows: 10—cylinder, 11—axial hole, 12—first blind hole, 13—second blind hole, 14—connecting rod, 20—first spline, 30—interlocking clinch feature, 33—displacer, 34—undercut, 41—flange surface, 42—second spline, 50—receiving structure, 51—first mounting hole, 52—second mounting hole, 53—third mounting hole, 61—fitting member, 62—bolts.

### Embodiment 1

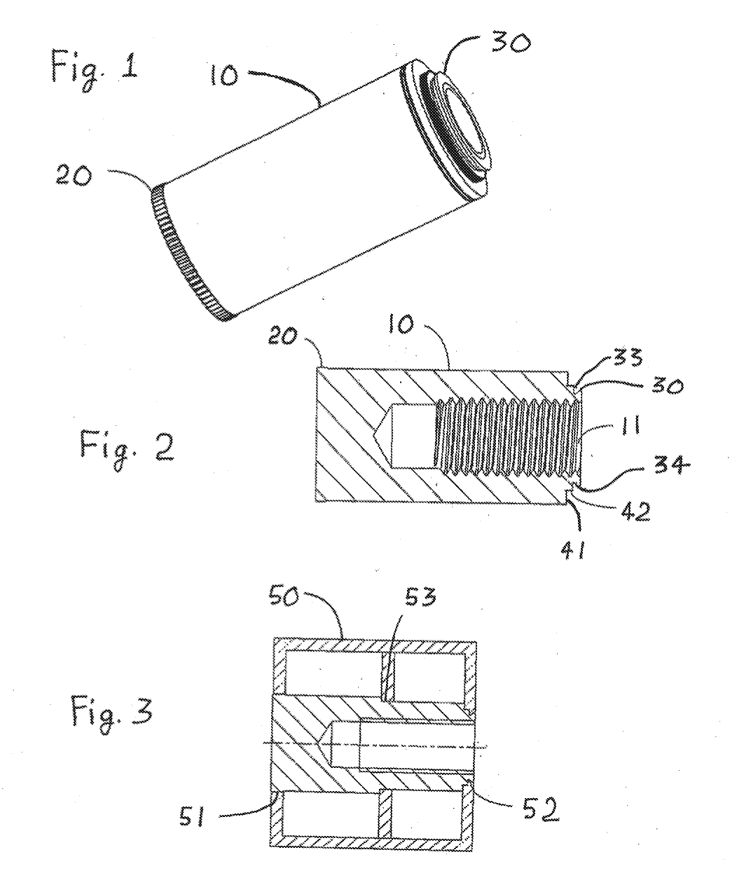

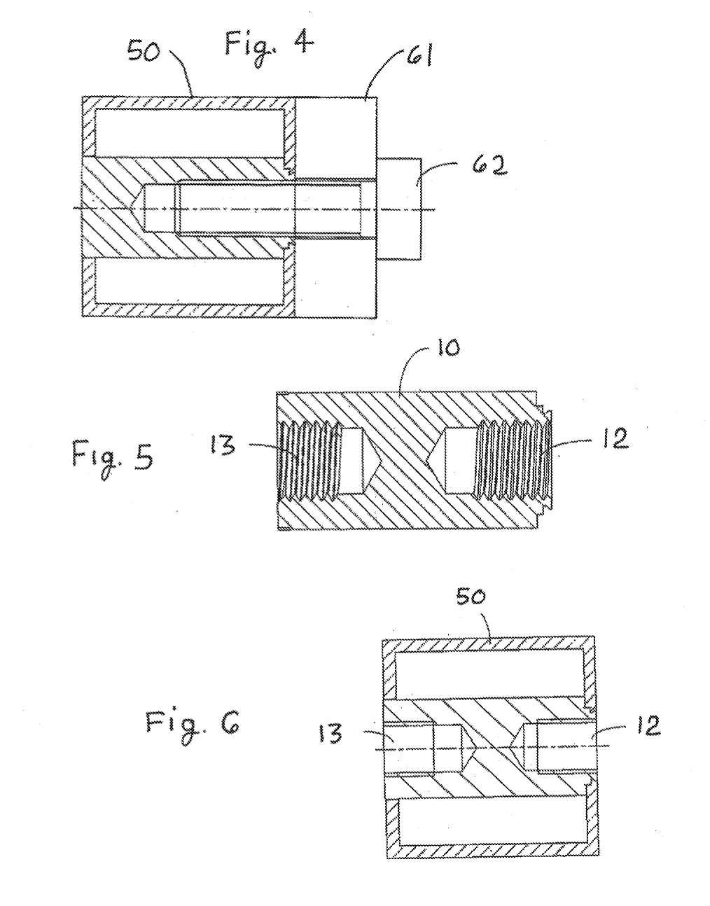

An insert providing a reinforced connecting structural member according to one embodiment of the invention is shown in FIGS. 1-4. In FIG. 3 we see the insert mounted into a receiving structure 50 having at least two parallel members with surfaces for fastened connection. As seen in FIG. 1, the insert comprises a cylinder 10 having a first end and a second end opposite to the first end; a first spline 20 disposed at the first end, wherein the first spline 20 is arranged circumferentially on an outer surface of the cylinder 10. The insert has a clinch 30 disposed at the second end of the cylinder 10 and circumferentially around the cylinder 10. The first spline 20 and the interlocking clinch 30 are respectively fastened to two parallel surfaces of the receiving structure 50, and at least one of the first and second ends of the cylinder 10 is fastened to a fitting member 61 through a connecting member as shown in FIG. 4. In the present disclosure, the first spline 20 is fitted to one surface of the receiving structure 50 with interference, and the interlocking clinch 30 is self-fastened with an opposing surface of the structure 50 due to material flow. In order to use the insert to realize fastened connection of the structure 50, there is no special requirement on the thickness and width of the walls of the structure, as well as tolerances of these parameters. The installation of the insert with the structure 50 is easy, without a need of welding or re-tapping, and thus cost and energy consumption for the installation is reduced. Moreover, the two surfaces of the structure 50 are connected together using a single component to increase connection reliability, and the cylinder 10 itself acts as a stiffener, thereby increasing the rigidity of the structure 50.

Optionally, as best shown in FIG. 3, all of the parallel members of the structure 50 have respective mounting holes aligned with a central axis. The first spline 20 is fitted to a first mounting hole 51 of the mounting holes of a first surface with interference. Specifically, at the first end where the first spline 20 is mounted, the cylinder 10 is in contact with and fastened with an inner surface of the first mounting hole 51 only through the first spline 20. In other words, a side of the cylinder where the first spline 20 resides does not need mounting members such as bases for further positional limitation and fastening to the structure 50. In this way, the requirement on dimensional accuracy of the structure 50 is low when the insert is mounted. Furthermore, any deformation of the structure 50 caused from excessively stretching can be avoided as well. The interlocking clinch 30 is connected to a second mounting hole 52 in a second surface of the structure 50 through pressing. Only the first mounting hole 51 and the second mounting hole 52 are operative. Alternatively, the receiving structure may include other mounting hole(s) 53 which may be or may not be in contact with the outer surface of the cylinder 10. Other structural features such as a step, interference fit, and the like may also be provided in the corresponding position(s) of the cylinder 10 to realize spacing, positional limitation or fastened connection between the outer surface of the cylinder 10 and the third mounting hole 53, or others.

Optionally, as best shown in FIG. 2, a step is disposed between the cylinder 10 and the interlocking clinch 30. The step includes a flange 41 perpendicular to an axial direction of the cylinder and a displacer parallel with the outer surface of the cylinder 10. An outer diameter of the cylinder 10 is larger than an outer diameter of the clinch displacer 33. Also, a second spline 42 is disposed on the displacer 33 outer surface of the interlocking clinch 30.

Referring to FIG. 3, the second spline 42 is disposed on the displacer 33 outer surface and the interlocking clinch 30 is self-locked with the second mounting hole 52 by the cold flow of metal from the affected surface into the clinch undercut 34. The second spline 42 may increase friction and improve the self-locking effect. After the insert is assembled, the flange 41 abuts the second surface and the second spline 42 is fully covered. Still referring to FIG. 3, the flange 41 is in abutment with a second surface of the receiving structure around the second mounting hole 52. An inner diameter of the second mounting hole 52 is larger than an outer diameter of the interlocking clinch 30, and is smaller than an outer diameter of the displacer. The flange 41 may provide a positional limitative effect during installation and may not be affected by the wall thickness of the receiving structure. In actual practice, the entire force system can withstand a large axial pull-out force due to the flange surface 41 of the cylinder 10 (the direction of the pull-out force is from the first spline 20 to the second spline 42).

As seen in FIGS. 2 to 4, an axial hole 11 is disposed in the cylinder 10. In the present embodiment, the axial hole 11 is a threaded blind hole and mates with a bolt 62, achieving fixed connection between the receiving structure 50 and a fitting member 61. As seen in FIG. 2 the clinch features 30 which occupy the receiving hole 52 include the displacer 42 and undercut 34. The cylinder 10 can be formed with the step and the first spline as a single piece, and may be made of an aluminum material, a carbon steel material, or a stainless steel material to achieve fastened connection while reducing material costs. The receiving structure 50 could be thin-walled aluminum tubing.

### Embodiment 2

An insert is also provided in another embodiment. As best shown in FIGS. 5 and 6, the structural member of this embodiment differs from that of the above embodiments in that, double-sided blind holes are disposed at both ends of the cylinder 10, i.e., the cylinder 10 has a first blind hole 12 and a second blind hole 13 at its inside, so that the receiving structure 50 may be connected to the fitting members 61 on both ends of the cylinder 10 through the first blind hole 12 and the second blind hole 13, respectively. The axial hole 11 may be one of a threaded through hole, an unthreaded blind hole, an unthreaded through hole, a half threaded hole, an unthreaded step hole.

### Embodiment 3

An insert is also provided in another embodiment. As best shown in FIGS. 7 and 8, the structural member of the present embodiment differs from those of the above embodiments in that, at least one of the two ends of the cylinder 10 has a connecting rod 14 extending axially from the cylinder 10, which may be an unthreaded rod or a threaded rod. In other words, in the present embodiment, the connection between the cylinder 10 and the fitting members 61 is realized through the connecting rod 14, and the corresponding connecting member may be replaced with a mating nut or the like.

In view of the above, the reinforced connecting insert provided by the present description can be used for connecting a receiving structure having at least two parallel surfaces to a fitting member. The insert includes a cylinder having a first end and a second end opposite to the first end; a first spline disposed at the first end of the cylinder, wherein the first spline is arranged circumferentially on an outer surface of the cylinder; and an interlocking clinch is disposed at the second end and circumferentially around the cylinder, wherein the first spline and the interlocking clinch are respectively fastened to the two spaced apart parallel members of the receiving structure, and at least one of the two ends of the cylinder is fastened to a fitting member through a connecting member. In the present disclosure, the first spline is fitted to one surface with interference, and the interlocking clinch is self-fastened with the other surface of the receiving structure due to material flow. When the insert is used to connect the receiving structure with an exterior fitting member, there is no special requirement on the wall thickness or width of the receiving structure, as well as tolerances of these parameters. The installation of the insert is easy, without a need of welding or re-tapping, and thus cost and energy consumption can be reduced. Moreover, the two facades of the receiving structure are connected together to increase connection reliability, and the cylinder itself acts as a stiffener, thereby increasing the rigidity of the receiving structure.

It will be apparent to those skilled in the art that various changes and modifications can be made to the present disclosure without departing from the spirit and scope of the present disclosure. In this way, if the modifications and variations of the present disclosure are within the scope of the present disclosure and the equivalents thereof, the present disclosure is intended to include such modifications and variations.

1. An insert for providing a connection to a receiving structure, comprising:
a receiving structure have at least two spaced-apart parallel members;
a cylinder having a first end and a second end opposite to the first end;
a first spline disposed at the first end of the cylinder, wherein the first spline is arranged circumferentially on an outer surface of the cylinder; and
an interlocking clinch comprising a displacer and an undercut disposed at the second end of the cylinder and circumferentially around the cylinder; and
wherein the first spline and the interlocking clinch are respectively fastened to the two spaced apart parallel surfaces of the receiving structure and at least one of the first and second ends of the cylinder is fastened to a fitting member by a connecting member.

2. The insert of claim 1, wherein each of the parallel members has a mounting hole aligned with a central axis, the first spline is fitted to a first mounting hole with interference, and the interlocking clinch is fitted to a second mounting hole by pressure riveting.

3. The insert of claim 2, further comprising:
a step disposed between the cylinder and the interlocking clinch, the step comprising a flange perpendicular to an axial direction of the cylinder and a displacer parallel with an outer surface of the cylinder; and,
wherein an outer diameter of the cylinder is larger than an outer diameter of the displacer.

4. The insert of claim 3, wherein the flange abuts a lateral surface around the second mounting hole and an inner diameter of the second mounting hole is larger than an outer diameter of the interlocking clinch, and smaller than an outer diameter of the displacer.

5. The insert of claim 3, wherein the displacer has a second spline.

6. The insert claim 4, further including an undercut on the cylinder located immediately below the displacer.

7. The insert of claim 2, wherein the cylinder is in contact with and fastened onto an inner surface of the first mounting hole at the first end of the cylinder only by the first spline.

8. The insert of claim 1, wherein the cylinder has a axial hole, the axial hole being one of a threaded blind hole, a threaded through hole, an unthreaded blind hole, an unthreaded through hole, a half-threaded hole, an unthreaded step hole, or a double-sided and double-ended blind hole.

9. The insert of claim 1, wherein at least one of the first and second ends of the cylinder has a connecting rod extending axially from the cylinder, the connecting rod being one of an unthreaded rod or a threaded rod.

10. The insert of claim 1, wherein the cylinder, the first spline and the interlocking clinch are formed as a single piece.

11. The insert of claim 1, wherein the cylinder is composed of one of an aluminum material, a carbon steel material, or a stainless steel material.
